(19) United States
(12) Patent Application Publication
(10) Pub. No.: US 2009/0144490 A1
(43) Pub. Date: Jun. 4, 2009

(54) METHOD, APPARATUS AND COMPUTER PROGRAM PRODUCT FOR PROVIDING IMPROVED MEMORY USAGE

(75) Inventors: Muralidhar K. Sridhar, Bangalore (IN); Rajeswari Kannan, Bangalore (IN); Sushma Shyamasundar, Bangalore (IN); Prashantha Kini, Bangalore (IN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/047,929

(22) Filed: Mar. 13, 2008

(30) Foreign Application Priority Data
Dec. 3, 2007 (IN) 2529/DEL/2007

(51) Int. Cl. G06F 12/02; G06F 12/00

(52) U.S. Cl. 711/104; 711/171; 711/115; 711/E12.001; 711/E12.002

(57) ABSTRACT

An apparatus for providing improved memory usage may include a processor. The processor may be configured to receive media content data, direct storage of up to a predetermined amount of a most recently received portion of the media content data into a first memory reservoir, and, in response to storing the predetermined amount in the first memory reservoir, transfer oldest portions of the received media content from the first memory reservoir to a second memory reservoir to maintain the storage in the first memory reservoir at the predetermined amount.

### CROSS-REFERENCE TO RELATED APPLICATIONS

This application claims the benefit of the filing date and priority to Indian Application No. 2529/DEL/2007 filed on Dec. 3, 2007, which is incorporated herein by reference in its entirety.

### FIELD OF THE INVENTION

Embodiments of the present invention relate generally to memory usage technology and, more particularly, relate to a method, apparatus and computer program product for providing improved memory usage such as by providing for a longer time of media playback, e.g., by providing improved memory usage by using a chained reservoir of relatively inexpensive MMC memory and a reduced amount of relatively expensive random access memory (RAM).

### BACKGROUND OF THE INVENTION

The modern communications era has brought about a tremendous expansion of wired and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

Services provided may include the provision of multimedia content for consumption at a mobile device. Moreover, given the ubiquitous nature of mobile devices such as cellular phones and other wireless communication devices, individual users are now able to produce, share and consume multimedia content while remaining mobile. In this regard, for example, individual users can create and/or consume audio and video content. Typically, when a user consumes multimedia content, the multimedia content may be downloaded to the user's device from a server or even directly from another user's device. The downloaded content may then be rendered at the user's device using a corresponding application.

Although such content may be created, downloaded and/or rendered at both mobile and fixed terminals, particularly in the context of mobile terminals, there may be limitations or restrictions placed on the amount or nature of resources available on the device (e.g., processing power, memory, display size limitations, etc.). In this regard, market demands often suggest that mobile terminals be limited in size and/or cost. RAM is one resource which may be more expensive (e.g., on a cost per megabyte (MB) basis) than some other memory alternatives such as, for example, flash memory or a hot-pluggable multimedia memory card (MMC). However, since RAM is desirable for use due to the speed at which information therein can be accessed, it may not always be practical to use other memory devices as a substitute for RAM.

Terminals capable of rendering multimedia content often include applications that provide feature capabilities like seeking/searching operations (e.g., fast forward, rewind, next, previous, etc.) and other operations (e.g., play, pause, stop, etc.). However, in order to accommodate pausing for a long period of time and/or seeking operations throughout the entirety of a particular media content item, an entirety of the particular media content item may need to be stored on the mobile device, for example, in the RAM of the device. Given the size of media content items such as, for example, videos like FlashVideo (FLV) by Adobe Inc., in order for videos of several minutes in length to be stored, very large and expensive RAM may be required. Moreover, other applications and even the application rendering the media content may also consume RAM.

Thus, given a particular RAM size and multimedia content of increasingly larger sizes, limits may be placed on the rendering capabilities of a device. For example, if a phone call is received during a download and rendering of media content and the rendering of the media content is paused during the call, the content rendering could be compromised if the incoming downloaded content is of a size larger than the RAM's storage capability. Additionally, download speeds may overtake content rendering and/or processing speeds so that RAM is consumed by downloaded data faster than the data is rendered until, for example, the RAM is filled and data must be released to make room for completion of the download. As such, content associated with the currently queued location may be deleted to make room for newly incoming content when the capacity limit of the RAM is reached. One mechanism for dealing with problems similar to those described above may be to store only as much data as required in a small window of time around the currently queued location and then releasing the data to enable storage of new data being downloaded. However, under this mechanism, if searching is desired within a media content item being rendered on a device in which the RAM is not sufficient to hold the entire media content item, portions of the media content item may be deleted to make room for incoming new data and thus, seeking operations may be limited.

Accordingly, it may be desirable to improve memory usage, such as by providing a memory management mechanism that may balance RAM usage with the usage of other low expense memory options in order to overcome at least some of the disadvantages described above.

### BRIEF SUMMARY OF THE INVENTION

A method, apparatus and computer program product are therefore provided that may provide improved memory usage by utilizing at least two different memory reservoirs with respect to storing downloaded multimedia content. In this regard, for example, one of the memory reservoirs may be RAM or another relatively higher cost memory device and another memory reservoir may be a lower cost memory device (e.g., a flash memory or MMC). Embodiments of the present invention may provide that, when downloading content, such content may be downloaded within the RAM or higher cost memory device until a particular threshold is reached, at which time further content may be downloaded to the other memory reservoir. In an exemplary embodiment, latest downloaded data may be stored in RAM and, when the particular threshold is reached, older data may be flushed out to the MMC. Accordingly, usage of the higher cost memory device may be managed (e.g., minimized) by utilizing (e.g., maximizing) less expensive memory in the other memory reservoir.

In one exemplary embodiment, a method for providing improved memory usage is provided. The method may include receiving media content data, directing storage of up to a predetermined amount of a most recently received portion of the media content data into a first memory reservoir, and, in response to storing the predetermined amount in the first memory reservoir, transferring older portions of the received media content from the first memory reservoir to a second memory reservoir to maintain the storage in the first memory reservoir at the predetermined amount.

In another exemplary embodiment, a computer program product for providing improved memory usage is provided, for example, for a mobile terminal. The computer program product includes at least one computer-readable storage medium having computer-readable program code portions stored therein. The computer-readable program code portions include first, second and third executable portions. The first executable portion is for receiving media content data. The second executable portion is for directing storage of up to a predetermined amount of a most recently received portion of the media content data into a first memory reservoir. The third executable portion is for transferring older portions of the received media content from the first memory reservoir to a second memory reservoir to maintain the storage in the first memory reservoir at the predetermined amount. The third executable portion may be executed in response to storing the predetermined amount in the first memory reservoir.

In another exemplary embodiment, an apparatus for providing improved memory usage is provided. The apparatus includes a processor configured to receive media content data, direct storage of up to a predetermined amount of a most recently received portion of the media content data into a first memory reservoir, and, in response to storing the predetermined amount in the first memory reservoir, transfer older portions of the received media content from the first memory reservoir to a second memory reservoir to maintain the storage in the first memory reservoir at the predetermined amount.

In another exemplary embodiment, an apparatus for providing improved memory usage is provided. The apparatus includes means for receiving media content data, means for directing storage of up to a predetermined amount of a most recently received portion of the media content data into a first memory reservoir, and means for, in response to storing the predetermined amount in the first memory reservoir, transferring older portions of the received media content from the first memory reservoir to a second memory reservoir to maintain the storage in the first memory reservoir at the predetermined amount.

Accordingly, embodiments of the present invention may provide a memory management mechanism that may enable advantageous balancing of the usage of memory resources, e.g., between expensive and inexpensive memory options. Accordingly, due to a reduction in RAM or higher cost memory usage, a smaller RAM may be utilized without suffering from reduced capabilities. Thus, bill of materials for devices such as mobile terminals may be reduced. Additionally, other exemplary embodiments of the invention address situations in which a computer program for seeking operations (e.g., fwd and backward), playback of multiple simultaneous media content, support for longer pause durations, etc., is provided.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a block diagram illustrating a memory management mechanism according to an exemplary embodiment of the present invention;

FIG. 4 is a diagram illustrating memory management instituted by a platform adaptation function according to an exemplary embodiment of the present invention;

FIG. 5 is a diagram illustrating memory management instituted by a platform adaptation function according to another exemplary embodiment of the present invention; and

FIG. 6 is a block diagram according to an exemplary method of providing improved memory usage according to an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

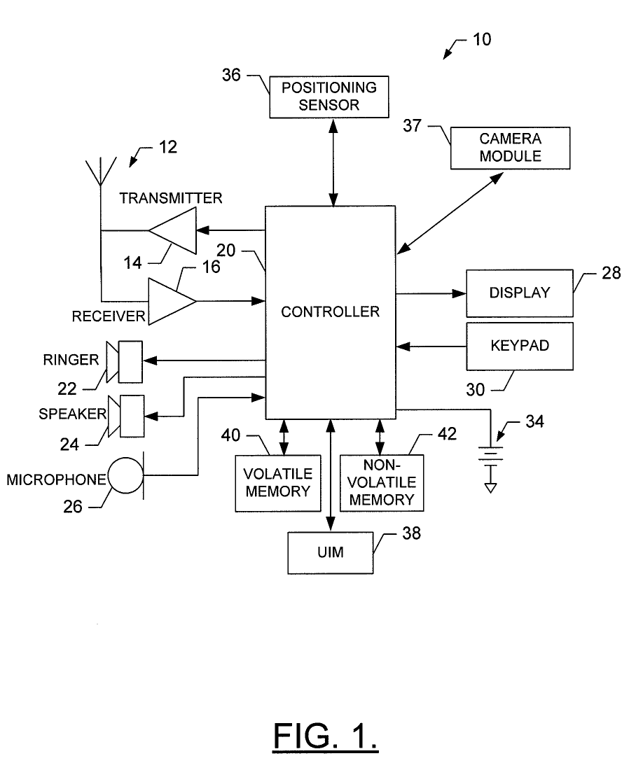

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of embodiments of the present invention are performed or used by a mobile terminal 10, the method may be employed by other than a mobile terminal (e.g., a television, personal computer (PC) or other fixed terminals or devices). Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

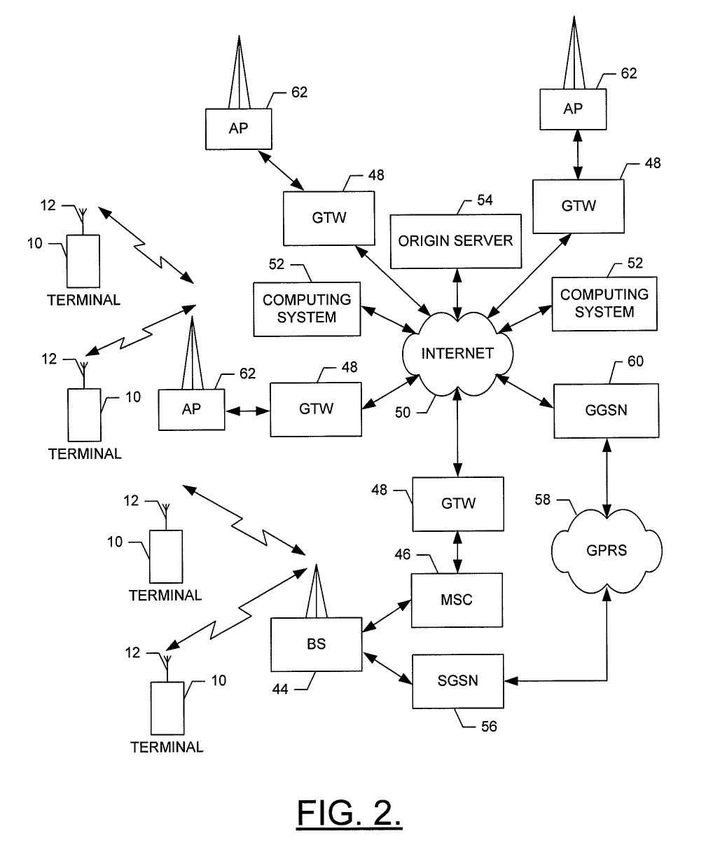

The mobile terminal 10 includes an antenna 12 (or multiple antennae) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus, such as the controller 20, may include means such as a device or circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point. Information from the positioning sensor 36 may then be communicated to a memory of the mobile terminal 10 or to another memory device to be stored as position history or location information.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

In an exemplary embodiment, the mobile terminal 10 may include a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image, or a video file from a series of captured image frames with or without accompanying audio data. As such, the camera module 37 includes all hardware, such as a lens or other optical device, and software necessary for creating a digital image, video or audio file from captured image/audio data. Alternatively, the camera module 37 may include only the hardware needed to capture an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard or other format.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wired or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wired or wireless communication techniques, including universal serial bus (USB), LAN, WLAN, WiMAX, UWB techniques and/or the like.

In an exemplary embodiment, content or data may be downloaded or otherwise communicated over the system of FIG. 2 between a mobile terminal, which may be similar to the mobile terminal 10 of FIG. 1, and another mobile terminal or a network device of the system of FIG. 2 in order to, for example, execute applications or establish communication (for example, for purposes of content sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

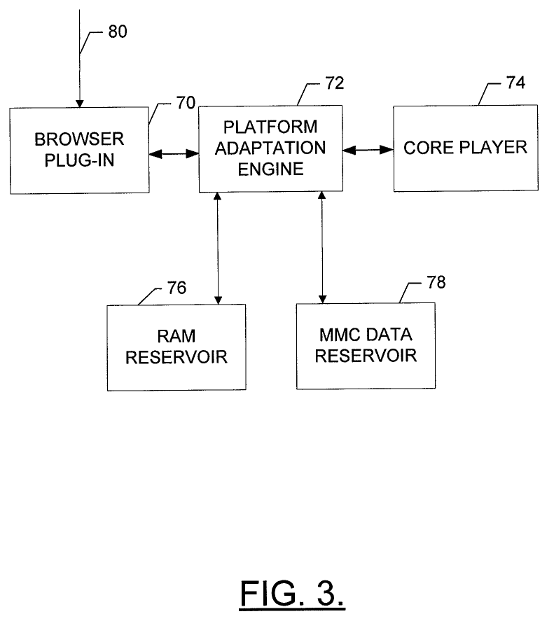

FIG. 3 is a diagram illustrating a memory management mechanism according to an exemplary embodiment of the present invention. As shown in FIG. 3, the mobile terminal 10 may include various entities, some of which may be in communication with each other and configured in order to enable practicing embodiments of the present invention. It should be noted, however, that while FIG. 3 illustrates one example of a configuration of a system for providing improved memory usage, numerous other configurations may also be used to implement embodiments of the present invention. In this regard, the mobile terminal 10 may include a browser plug-in 70, a platform adaptation engine 72 and a core player 74. Each of the browser plug-in 70, the platform adaptation engine 72 and the core player 74 may be any means, such as a device or circuitry, embodied in either hardware, software, or a combination of hardware and software that is configured to perform the corresponding functions of the browser plug-in 70, the platform adaptation engine 72 and the core player 74, respectively.

In an exemplary embodiment, the browser plug-in 70 may be embodied as a device or means, such as circuitry or a computer program, which may interact with a host application to provide a certain function “on demand”. In this regard, the browser plug-in 70 may provide a mechanism through which data such as streaming or other media content may be downloaded from a network device or other terminal (e.g., via the system of FIG. 2).

The core player 74 may include any of a number of different devices configured to provide playback and/or rendering capabilities with respect to media content or files. For example, the core player 74 may include a television (TV) monitor, wireless monitor, game console, PC, stereo and home theater, video and imaging capture and/or playback device, multimedia mobile terminal, game console, etc. In some embodiments, the core player 74 may be embodied as a virtual machine or computer program for rendering or playing back multimedia files via the display and/or speaker of the mobile terminal 10. As such, for example, the core player 74 may be configured to render audio and/or video data such as in a particular audio or video file that may be downloaded to the mobile terminal 10 for rendering via the core player 74. One example of a core player may be a flash video player, however, numerous similar core players are also known in the art and could be embodied as the core player 74.

In some embodiments, the core player 74 may include a local buffer (e.g., a live data buffer) for temporary storage of data for rendering via the core player 74. As such, a user may request (e.g., via a request made by the user using a user interface of the mobile terminal 10) that data or a particular multimedia content file 80 corresponding to audio or video multimedia content be downloaded to the mobile terminal 10 for rendering via the core player 74. In such a scenario, the core player 74 may initiate the download of the particular multimedia content file 80 via the browser plug-in 70 (e.g., and ultimately via a browser). The data downloaded via the browser plug-in 70 may then be communicated to the platform adaptation engine 72, which may manage storage of the data downloaded (e.g., the particular multimedia content file 80) as described in greater detail below. The stored data may then be accessed by the core player 74 via the platform adaptation engine 72 for playback when desired.

The mobile terminal 10 may also include a first memory reservoir (e.g., RAM reservoir 76), which may, in some embodiments, be considered a portion of a relatively more expensive memory resource, and a second memory reservoir (e.g., MMC data reservoir 78), which may be considered a portion of a relatively less expensive resource than the first memory reservoir. An embodiment of the present invention will now be described in relation to the RAM reservoir 76 and the MMC data reservoir 78, which should be recognized as merely examples of the first and second memory reservoirs, respectively. In this regard, the RAM reservoir 76 may be a predefined portion of the volatile memory 40 of the mobile terminal 10 and the MMC data reservoir 78 may be a predefined portion of the non-volatile memory 42 of the mobile terminal 10. However, the data in the MMC data reservoir 78 may be deleted when corresponding content (e.g., a video instance) is deleted. The MMC data reservoir 78 may be, for example, a portion of a flash memory or pluggable memory card, which may be inserted into the mobile terminal 10 to add additional memory capability. However, the second memory reservoir need not necessarily be a portion of a removable memory device.

Generally, as described above, the platform adaptation engine 72 may be any means, such as a device or circuitry, embodied in either hardware, software, or a combination of hardware and software that is configured to perform the corresponding functions of the platform adaptation engine 72. However, in some embodiments, the platform adaptation engine 72 may be embodied as a virtual machine or computer program for managing memory usage of the mobile terminal 10 at least with respect to data downloads initiated by the core player 74. As such, the platform adaptation engine 72 may be embodied as a processing element (e.g., the controller 20) configured to execute instructions stored in a computer readable storage medium. Processing elements such as those described herein may be embodied in many ways. For example, the processing element may be embodied as a processor, a coprocessor, a controller or various other processing means or devices including integrated circuits such as, for example, an ASIC (application specific integrated circuit). The platform adaptation engine 72 may act as a host upon which the core player 74 runs. As such, the platform adaptation engine 72 may host applications that communicate for the purpose of rendering media content (e.g., playing a flash video) as described herein.

In an exemplary embodiment, the platform adaptation engine 72 may be configured to manage memory usage of the mobile terminal 10 by providing memory spillover functions to spill or transfer data ingress over from the RAM reservoir 76 to the MMC data reservoir 78 in certain situations in order to utilize the MMC data reservoir 78 to provide increased downloaded data storage capability, while reducing an amount of RAM reservoir 76 usage requirements with respect to any one particular multimedia content file, virtually regardless of the size of the file. As indicated above, the platform adaptation engine 72 may further provide for copying of downloaded data from the RAM reservoir 76 and/or the MMC data reservoir 78 to the buffer of the core player 74 for playback.

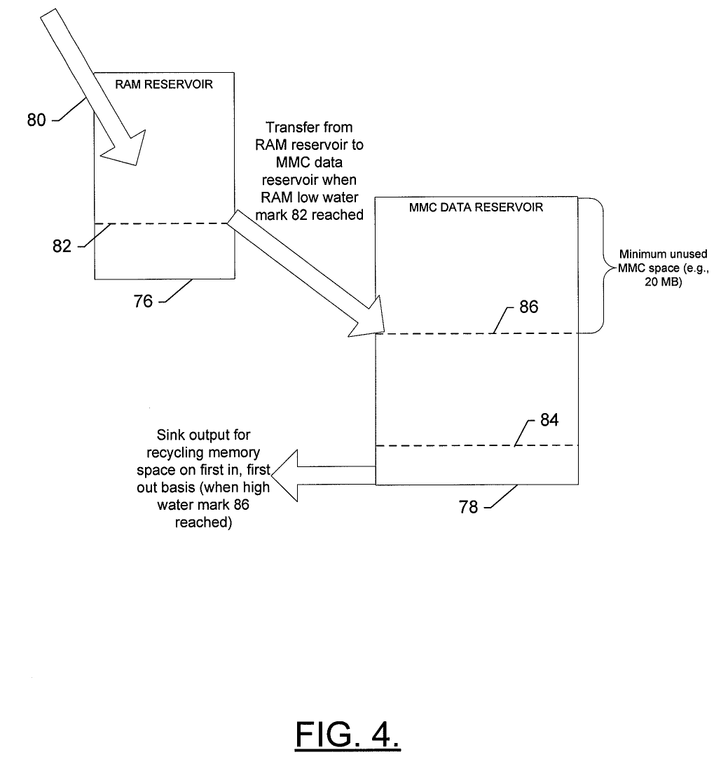

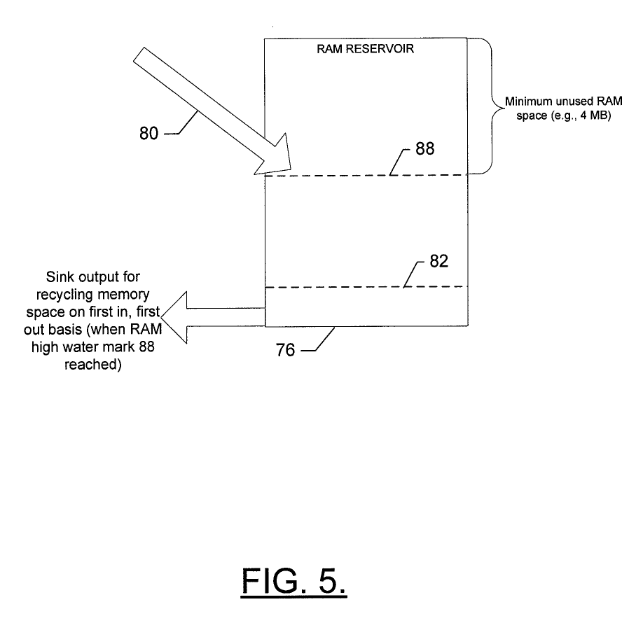

FIGS. 4 and 5 illustrate examples of the memory management provided by the platform adaptation engine 72. However, FIGS. 4 and 5 are merely exemplary and should not be taken as limitations to embodiments of the present invention. Moreover, values and sizes related to storage capacity defined below should be understood to be examples and not limiting in any way. In this regard, for one exemplary embodiment, the buffer of the core player 74 could be about 1 MB of tunable memory for storing data being rendered, played or otherwise interpreted by the core player 74 at a particular instance in a time-window. The RAM reservoir 76 may be, for example, 1 MB or 4 MB in size and may store data trailing behind the initial data such as a predetermined amount of most recently downloaded data. Meanwhile, an MMC or flash disk (or any other memory device of lower expense than the RAM) of any size (e.g., 1 GB to 8 GB) may be chained or linked with the RAM so that a portion of the MMC or flash disk, for example, about 100 MB of the MMC, may be defined as the MMC data reservoir 78.

FIG. 4 is a diagram illustrating memory management instituted by a platform adaptation function according to an exemplary embodiment of the present invention. In this regard, FIG. 4 illustrates an embodiment in which RAM and an MMC are chained or linked for media content storage/playback in accordance with an embodiment of the present invention. As illustrated in FIG. 4, a predetermined amount of the RAM may be defined to correspond to the RAM reservoir 76. Data corresponding to the particular multimedia content file 80 being downloaded may be directed by the platform adaptation engine 72 for storage in the RAM reservoir 76. Once the predetermined amount is reached, the platform adaptation engine 72 may direct a spillover of data to be stored in the MMC data reservoir 78. In this regard, data stored in the MMC data reservoir 78 may include data transferred thereto from the RAM reservoir 76. The data transferred to the MMC data reservoir 78 from the RAM reservoir 76 may be transferred on a first in, first out basis. In other words, the first data into the RAM reservoir is transferred out to the MMC data reservoir 78 when the predetermined amount is reached and follow-on data is also transferred out of the RAM reservoir 76 on a first in, first out basis in order to maintain the predetermined amount of the most recently downloaded data in the RAM reservoir 76. As such, in this embodiment, the predetermined amount may be an upper limit to the amount of memory space of the RAM reservoir 76 that may be consumed for the media content file being downloaded. In an exemplary embodiment, after the RAM reservoir 76 is filled (e.g., the pre-determined amount is reached), it is a one time write to the MMC data reservoir 78.

As shown in FIG. 4, the predetermined amount corresponding to a size of the RAM reservoir 76 may be considered a RAM low water mark 82, such that when the RAM low water mark 82 is reached (e.g., 1 MB of downloaded data), a spillover of data (e.g., on a first in, first out basis) may begin to be directed to the MMC data reservoir 78. In an exemplary embodiment, a size of the MMC data reservoir 78 may be variable in order to ensure that an amount of resources allocated to any particular download of data may not be rigidly set to a value that results in an allocation of too many resources to the particular download of data. For example, the MMC data reservoir 78 may include a low water mark 84 (e.g., a 20 MB minimum) defining a minimum amount of MMC resources allocated to the download of the particular multimedia content file 80 and a high water mark 86 (e.g., a 100 MB maximum) defining an amount above which further data associated with the particular multimedia content file 80 may not be stored. If the high water mark 86 of the MMC data reservoir 78 is reached, memory space may be released (e.g., data may be deleted) to create space for incoming data on a first in, first out basis. In some embodiments, the high water mark 86 may not be defined as a specific value, but instead as a variable value based on providing a minimum amount of unutilized MMC memory space.

Thus, in accordance with the embodiment of FIG. 4, for a download of data associated with the particular multimedia content file 80, incoming data may initially be stored in the RAM reservoir 76 up to the predetermined amount (e.g., 1 MB). After the predetermined amount is reached, data may flow from the RAM reservoir 76 to the MMC data reservoir 78 on a first in, first out basis, thereby providing that a quantity of data about equal to the predetermined amount of the most recently downloaded data is stored in the RAM reservoir 76. Data flowing from the RAM reservoir 76 may then be stored in the MMC data reservoir 78 until the high water mark 86 is reached, at which time the memory space of the MMC data reservoir 78 may be released so that data is deleted or discarded on a first in, first out basis. For data consumption or playback, the platform adaptation engine 72 may check either or both of the RAM reservoir 76 and the MMC data reservoir 78 for data retrieval (e.g., for playback or seek operations) for data availability based on a value of a data offset (e.g., the byte offset from which data is requested or the read pointer in the queue). In other words, for example, the platform adaptation engine 72 may check the RAM reservoir 76 and/or the MMC data reservoir 78 to determine a location of, and thereafter access, data that corresponds to the data that is to be played. The core player 74 may also have an internal buffer from which playback or seek operations may be conducted. If the data that is to be played back is not found in the first reservoir accessed, then the platform adaptation engine 72 may check the other. In an exemplary embodiment, the MMC data reservoir 78 may be checked first due to the fact that the relative sizes of the MMC data reservoir 78 and the RAM reservoir 76 may be such that the data to be played back is more likely to be located in the MMC data reservoir 78. However, other rules for determining where to look for data may also be provided. Additionally, data transfers (and/or deletions) from the RAM reservoir 76 and the MMC data reservoir 78 may commence in response to data levels reaching any of the high and/or low water marks described herein. Thus, the descriptions provided herein are merely exemplary.

FIG. 5 is a diagram illustrating memory management instituted by a platform adaptation function according to another exemplary embodiment of the present invention. In the embodiment of FIG. 5, the MMC data reservoir 78 may not be available (e.g., due to the MMC card being removed, full or otherwise fully allocated to other operations). Since the MMC data reservoir 78 is not available, the platform adaptation engine 72 cannot spill data over to the MMC data reservoir 78 when the RAM low water mark 82 of the RAM reservoir 76 is reached. However, since it may be desirable to provide for more storage than merely the amount that corresponds to the low water mark, the platform adaptation engine 72 may be configured to apply a RAM high water mark 88 if the MMC data reservoir 78 is not available. The RAM high water mark 88 may define a maximum amount of storage space that may be assigned to the download of any particular media content file. As such, the RAM high water mark 88 may act as the predetermined amount defining a maximum amount of data that may be stored in association with a particular media content file. Thus, for example, as shown in FIG. 5, a 4 MB RAM high water mark 88 may be defined such that when the amount of stored data for the particular media content file reaches the RAM high water mark 88, data may begin to be discarded on a first in, first out basis so that only the 4 MB of data most recently downloaded may be stored in the RAM reservoir 76.

In an exemplary embodiment, a value corresponding to the RAM high water mark 88 may be variable in order to ensure that an amount of resources allocated to any particular download of data may not be rigidly set to a value that results in an allocation of too many resources to the particular download of data. For example, the RAM high water mark 88 may not be defined as a specific value, but instead as a variable value based on providing a minimum amount of unutilized RAM memory space with respect to total RAM capacity. In other words, the RAM high water mark may be set to maintain a minimum of RAM unutilized space (e.g., 4 MB) or may be set as a fraction of the RAM space available to maintain the minimum of RAM unutilized space.

Accordingly, the platform adaptation engine 72 may define rules and/or procedures for memory management as defined herein. In various exemplary embodiments, the rules defined by the platform adaptation engine 72 may include provision of the various size allocations to be provided for the RAM reservoir 76 and/or the MMC data reservoir 78. Such size allocations may include values corresponding to high and/or low watermarks. Furthermore, the platform adaptation engine 72 may define whether the various size allocations are variable under certain circumstances. For example, if the MMC data reservoir 78 is not available the RAM high water mark may be defined, whereas the RAM high water mark may not be defined if the MMC data reservoir 78 is available. In other words, the platform adaptation engine 72 may provide for a particular amount of RAM space to be utilized if a chained or linked reservoir of memory space can be utilized to reduce reliance upon RAM, and a larger amount of RAM space may be provided for utilization for data download if the chained or linked reservoir of memory space is not available. Additionally, the sizes of the RAM and/or MMC data reservoirs may be set to a variable amount based on maintaining a minimum amount of unused RAM or MMC space for use by other applications.

It should also be noted that the platform adaptation engine 72 may perform the operations described above for each download or data transfer operation. Accordingly, for example, if multiple media content downloads are requested during a particular period of time, the platform adaptation engine 72 may define corresponding multiple RAM and/or MMC data reservoirs for each media content download operation. The platform adaptation engine 72 could also define different values at which the operations described above are performed based on the number of currently active downloading operations.

Accordingly, some embodiments may provide a reduced reliance upon RAM resources for storage, which may translate to lower bill of material costs. Additionally, since less RAM may be required for any particular media file, media files such as videos of longer lengths may be rendered with increased access to functionality such as long pause durations (and therefore possibly support for longer phone calls while a video is paused), a longer window over which seek operations may be performed, etc. Moreover, intricate operations, e.g., most frequently performed operations like write operations, can be done in RAM and the data may be committed to the MMC to improve performance. In an exemplary embodiment, data may be committed to the MMC only when the predetermined limit of the RAM reservoir is reached. Thus the frequency of these writes may be comparatively less.

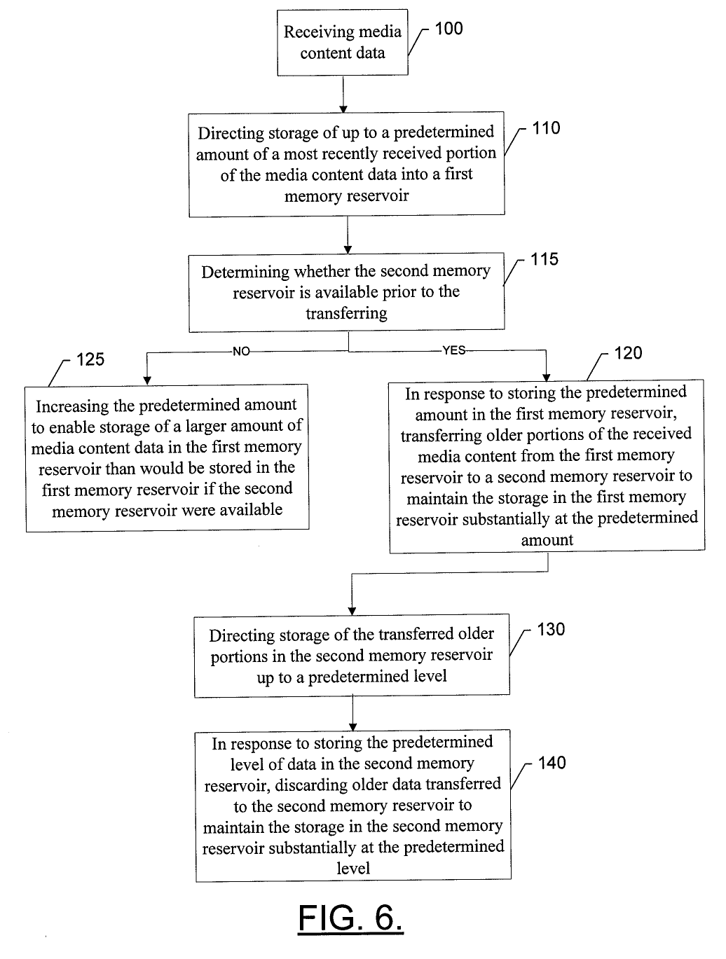

FIG. 6 is a flowchart of a method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing improved memory usage, as shown in FIG. 6, may include receiving media content data at operation 100. Storage of up to a predetermined amount of a most recently received portion of the media content data may be directed into a first memory reservoir at operation 110. In response to storing the predetermined amount in the first memory reservoir, oldest portions (e.g., less recently received or older portions) of the received media content may be transferred from the first memory reservoir to a second memory reservoir to maintain the storage in the first memory reservoir at the predetermined amount at operation 120. It should be noted that the older or oldest portions referred to herein refer to “age” that is based on receipt into the memory reservoir and not date of creation, content of data, etc. Additionally, the predetermined amount need not be a fixed number, but could be a range, a percentage, or a value with a fixed or random variation assigned thereto, etc.

In an exemplary embodiment, the method may include several other optional operations as defined below and illustrated in FIG. 6. For example, the method may further include directing storage of the transferred oldest portions in the second memory reservoir up to a predetermined level at operation 130. In response to storing the predetermined level of data in the second memory reservoir, oldest data transferred to the second memory reservoir may be discarded at operation 140 to maintain the storage in the second memory reservoir at the predetermined level. Operation 115 may include determining whether the second memory reservoir is available prior to operation 120. In this regard, if the second memory reservoir is not available, the method may further include increasing the predetermined amount to enable storage of a larger amount of media content data in the first memory reservoir than would be stored in the first memory reservoir if the second memory reservoir were available at operation 125.

In an exemplary embodiment, operation 100 may include receiving more than one media content files and the directing and transferring operations (e.g., 110 and 120) may be performed with respect to a separate first and second memory reservoir for each of the more than one media content files (e.g., a first and second memory reservoir for a first media content file and a separate first and second memory reservoir for the second media content file). Operation 110 may include directing storage into a portion of RAM storage and operation 120 may include transferring data to a removable memory card. Operation 100 could alternatively include downloading streamed video data and thus, the method may further include determining whether a data offset is disposed in the first or second memory reservoir and accessing the streamed video data at a location corresponding to the data offset. In such an embodiment, the streamed video data proximate to the data offset may be copied to a core player.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving media content data;
directing storage of up to a predetermined amount of a most recently received portion of the media content data into a first memory reservoir; and
in response to storing the predetermined amount in the first memory reservoir, transferring older portions of the received media content from the first memory reservoir to a second memory reservoir to maintain the storage in the first memory reservoir at the predetermined amount.

2. The method of claim 1, further comprising directing storage of the transferred older portions in the second memory reservoir up to a predetermined level.

3. The method of claim 2, further comprising, in response to storing the predetermined level of data in the second memory reservoir, discarding older data transferred to the second memory reservoir to maintain the storage in the second memory reservoir at the predetermined level.

4. The method of claim 1, further comprising determining whether the second memory reservoir is available prior to the transferring, wherein if the second memory reservoir is not available, the method further comprises increasing the predetermined amount to enable storage of a larger amount of media content data in the first memory reservoir than would be stored in the first memory reservoir if the second memory reservoir were available.

5. The method of claim 1, wherein receiving media content data comprises receiving more than one media content files and wherein the directing and transferring operations are performed with respect to a separate first and second memory reservoir for each of the more than one media content files.

6. The method of claim 1, wherein directing storage into the first memory reservoir comprises directing storage into a portion of random access memory storage and wherein transferring older portions of the received media content to the second memory reservoir comprises transferring data to a removable memory card.

7. The method of claim 1, wherein receiving media content data comprises downloading streamed video data and wherein the method further comprises determining whether a data offset is disposed in the first or second memory reservoir and accessing the streamed video data at a location corresponding to the data offset.

8. The method of claim 7, further comprising copying the streamed video data proximate to the data offset to a core player.

9. A computer program product comprising at least one computer-readable storage medium having computer-readable program code portions stored therein, the computer-readable program code portions comprising:
a first executable portion for receiving media content data;
a second executable portion for directing storage of up to a predetermined amount of a most recently received portion of the media content data into a first memory reservoir; and
a third executable portion for, in response to storing the predetermined amount in the first memory reservoir, transferring older portions of the received media content from the first memory reservoir to a second memory reservoir to maintain the storage in the first memory reservoir at the predetermined amount.

10. The computer program product of claim 9, further comprising a fourth executable portion for directing storage of the transferred older portions in the second memory reservoir up to a predetermined level.

11. The computer program product of claim 10, further comprising a fifth executable portion for, in response to storing the predetermined level of data in the second memory reservoir, discarding older data transferred to the second memory reservoir to maintain the storage in the second memory reservoir at the predetermined level.

12. The computer program product of claim 9, further comprising:
a fourth executable portion for determining whether the second memory reservoir is available prior to the transferring, and
a fifth executable portion for, if the second memory reservoir is not available, increasing the predetermined amount to enable storage of a larger amount of media content data in the first memory reservoir than would be stored in the first memory reservoir if the second memory reservoir were available.

13. The computer program product of claim 9, wherein the first executable portion includes instructions for receiving more than one media content files and wherein the directing and transferring operations are performed with respect to a separate first and second memory reservoir for each of the more than one media content files.

14. The computer program product of claim 9, wherein the second executable portion includes instructions for directing storage into a portion of a random access memory storage and wherein the third executable portion includes instructions for transferring data to a removable memory card.

15. The computer program product of claim 9, wherein the first executable portion includes instructions for downloading streamed video data and wherein the computer program product further comprises a fourth executable portion for determining whether a data offset is disposed in the first or second memory reservoir and accessing the streamed video data at a location corresponding to the data offset.

16. The computer program product of claim 15, further comprising a fifth executable portion for copying the streamed video data proximate to the data offset to a core player.

17. An apparatus comprising a processor configured to:
receive media content data;
direct storage of up to a predetermined amount of a most recently received portion of the media content data into a first memory reservoir; and
in response to storing the predetermined amount in the first memory reservoir, transfer older portions of the received media content from the first memory reservoir to a second memory reservoir to maintain the storage in the first memory reservoir at the predetermined amount.

18. The apparatus of claim 17, wherein the processor is further configured to direct storage of the transferred older portions in the second memory reservoir up to a predetermined level.

19. The apparatus of claim 18, wherein the processor is further configured to, in response to storing the predetermined level of data in the second memory reservoir, direct a discarding of older data transferred to the second memory reservoir to maintain the storage in the second memory reservoir at the predetermined level.

20. The apparatus of claim 17, wherein the processor is further configured to determine whether the second memory reservoir is available prior to the transferring and, if the second memory reservoir is not available, increase the predetermined amount to enable storage of a larger amount of media content data in the first memory reservoir than would be stored in the first memory reservoir if the second memory reservoir were available.

21. The apparatus of claim 17, wherein the processor is further configured to receive more than one media content files and wherein the directing and transfer operations are performed with respect to a separate first and second memory reservoir for each of the more than one media content files.

22. The apparatus of claim 17, wherein the processor is further configured to direct storage into a portion of a random access memory storage comprising the first memory reservoir and transfer data to a removable memory card comprising the second memory reservoir.

23. The apparatus of claim 17, wherein the processor is further configured to download streamed video data and determine whether a data offset is disposed in the first or second memory reservoir and to access the streamed video data at a location corresponding to the data offset.

24. The apparatus of claim 23, wherein the processor is further configured to copy the streamed video data proximate to the data offset to a core player.

25. An apparatus comprising:
means for receiving media content data;
means for directing storage of up to a predetermined amount of a most recently received portion of the media content data into a first memory reservoir; and
means for transferring older portions of the received media content from the first memory reservoir to a second memory reservoir to maintain the storage in the first memory reservoir at the predetermined amount in response to storing the predetermined amount in the first memory reservoir.
